(19) United States
(12) Patent Application Publication
(10) Pub. No.: US 2016/0284108 A1
(43) Pub. Date: Sep. 29, 2016

(54) DATA QUALITY MEASUREMENT METHOD BASED ON A SCATTER PLOT

(71) Applicant: SHENZHEN AUDAQUE DATA TECHNOLOGY LTD, Shenzhen, Guangdong (CN)

(72) Inventors: Mingxing Wang, Shenzhen (CN); Wenfei Fan, Shenzhen (CN); Xibei Jia, Shenzhen (CN)

(21) Appl. No.: 14/748,644

(22) PCT Filed: Aug. 18, 2014
(86) PCT No.: PCT/CN2014/084608

§ 371 Date: Jun. 24, 2015

(30) Foreign Application Priority Data
Sep. 26, 2013 (CN) 201310443454.1

(51) Int. Cl. G06T 11/20; G06F 3/0482; G06F 3/0484

(52) U.S. Cl. CPC G06T 11/206; G06F 3/04845; G06F 3/0482

(57) ABSTRACT

A data quality measurement method based on a scatter plot, the method comprising: defining a data grid (Gxy) and fitting a plurality of trend lines; using a scatter plot to display data and according to actual trends, selecting a trend line and displaying same; generating data quality rules according to the determined trend line type and parameters; selecting appropriate data quality rules and measuring data quality according to a threshold. By means of defining the data grid (Gxy) to store data, using a scatter plot to display data, and generating data quality rules according to the determined trend line type and parameters, and further setting a threshold according to said rules and measuring data quality, applications such as display of data, analysis of abnormal data, and data error correction can be performed for enormous amounts of data. Another embodiment provides a data quality measurement system based on a scatter plot.

### TECHNICAL FIELD

The present disclosure relates to data field, and particularly to a data quality measurement method and system based on a scatter plot.

### BACKGROUND

A scatter plot, also known as a scatter distribution map, refers to a graph having a variable on the horizontal axis and another variable on the vertical axis which reflects statistical relationship among variables by using distribution pattern of scatters (coordinate points). It is featured by displaying directly the overall trend of relationship between an expected object and an influence factor. The relationship among variables can be simulated by a mathematical expression determined by taking advantage of reflecting the changes of the relationship among variables through an intuitive graph. Such a scatter plot can not only broadcast the type information of relationship among variables, but also can reflect the definition of relationship among variables. However, a simple scatter plot can only represent a small amount of data, which leads to series of problems such as abnormally slow response speed resulted from too many points needed to be displayed in the case of enormous amounts of data. Moreover, the simple scatter plot is a tool only for displaying without functions such as interaction, viewing detailed description of data, and data error correction. Therefore, it is desired to provide a method for showing the distribution of two-dimensional data based on a scatter plot, analyzing abnormal data and performing data error correction.

### SUMMARY

For this purpose, the present disclosure is aimed to solve one of the above-mentioned drawbacks.

Therefore, the present disclosure provides a data quality measurement method and system based on a scatter plot. By means of defining a data grid Gxy to store data, using a scatter plot to display data, and generating data quality rules according to a determined trend line, and further setting a threshold according to said rules to measure data quality, applications like display of data, analysis of abnormal data and data error correction can be performed for enormous amounts of data.

As a result, a data quality measurement method based on a scatter plot is provided in one embodiment of the present disclosure, the method comprising: defining a data grid (Gxy) and fitting a plurality of trend lines; using a scatter plot to display data and according to actual trends, selecting a trend line and displaying same; generating data quality rules according to the determined trend line type and parameters; selecting appropriate data quality rules according to a threshold.

In one embodiment of the present disclosure, defining a data grid (Gxy) and fitting a plurality of trend lines comprise:

defining a data grid (Gxy) and scanning a data source;

reading the data source, analyzing the stored data, and correcting the display scale of the X axis;

for every effective data grid (Gxy) of every effective display scale, according to the total record numbers as well as the sums of X and Y, calculating the average values of X and Y;

for every Gx of every effective display scale, calculating the general average value of X and the general average value of Y, and fitting every type of trend line based on the general average values.

Preferably, the adopted trend line types comprise: straight line, logarithmic curve, exponential curve, quadratic curve, Gompertz curve, logistic curve, periodic curve and so on.

Preferably, the data information displayed by using a scatter plot at least comprises: scattered information of data, the average line of all Gx, the fitted trend lines and so on.

In one embodiment of the present disclosure, selecting a trend line according to actual trends of the data comprises:

displaying the types of the trend lines on the scatter plot, performing selection according to actual trends of the data;

manually adjusting the parameters of the trend line when the fitted trend line parameters fail to satisfy current data display; wherein the adjustment is achieved by means of directly adjusting the trend line formula in the scatter plot, or providing each parameter with support of dragging a mouse to modify the trend line and display the change of the trend line in real time when dragging the mouse to modify the trend line in the scatter plot.

In one embodiment of the present disclosure, generating data quality rules comprises:

providing that the trend line is y=f(x), i.e., for a value x, the target value y can be calculated according to the trend line;

setting a threshold for the target value to generate data quality rules.

Preferably, the threshold is set to be an absolute value.

Preferably, the threshold is set to be in the form of a percentage.

In one embodiment of the present disclosure, measuring data quality comprises:

selecting appropriate data quality rules based on the actual situation of displaying data in the scatter plot, for each input data (x,y), calculating the target value y′ corresponding to x according to the trend line technique of the rules;

configuring the threshold to be a value or a percentage, calculating the reasonable interval of the target value to judge the data quality of the actual value y.

A data quality measurement system based on a scatter plot is provided in another embodiment of the present disclosure, the system comprising:

a trend line fitting unit configured for defining a data grid Gxy and obtaining the information of fitting a plurality of trend lines;

a data display unit configured for using a scatter plot to display data and according to actual trends of the data, selecting a trend line and displaying same;

a data quality rules generating unit configured for generating data quality rules according to the determined trend line type and parameters and obtaining information of data quality rules;

a data quality measuring unit configured for selecting appropriate data quality rules, measuring data quality according to a threshold, and obtaining the result of data quality measurement.

Preferably, the trend line types selected by the data display unit comprise: straight line, logarithmic curve, exponential curve, quadratic curve, Gompertz curve, logistic curve, periodic curve and so on.

In one embodiment of the present disclosure, the data display unit selecting a trend line and displaying same according to actual trends of the data comprise:

displaying the types of the trend lines on the scatter plot, performing selection according to actual trends of the data;

manually adjusting the parameters of the trend line when the fitted trend line parameters fail to satisfy current data display; wherein

the adjustment is achieved by means of directly adjusting the trend line formula in the scatter plot, or providing each parameter with support of dragging a mouse to modify the trend line and display the change of the trend line in real time when dragging the mouse to modify the trend line in the scatter plot.

In one embodiment of the present disclosure, the data quality rules generating unit generating data quality rules comprises: providing that the trend line is y=f(x), i.e., for a value x, the target value y can be calculated according to the trend line; setting a threshold for the target value to generate data quality rules. By means of defining a data grid Gxy to store data, using a scatter plot to display data, and generating data quality rules according to a determined trend line type and parameters, and further setting a threshold according to said rules and measuring data quality, applications such as display of data, analysis of abnormal data and data error correction can be performed for enormous amounts of data.

### BRIEF DESCRIPTION OF THE DRAWINGS

FIG. 1 is a detailed flowchart illustrating the data quality measurement method based on a scatter plot provided by one embodiment of the present disclosure.

FIG. 2 is a schematic diagram of the data grid Gxy defined in one embodiment of the present disclosure.

### DETAILED DESCRIPTION

The present disclosure will be described in detail by reference to the accompanying drawings and embodiments for more clearly understanding of the objects, technical features and advantages of the present disclosure. It should be understood that specific embodiments described herein are intended for purposes of illustration only and are not intended to limit the scope of the present disclosure.

The present disclosure provides a data quality measurement method and system based on a scatter plot. By means of defining a data grid Gxy to store data, using a scatter plot to display data, and generating data quality rules according to a determined trend line type and parameters, and further setting a threshold according to said rules and measuring data quality, applications such as display of data, analysis of abnormal data and data error correction can be performed for enormous amounts of data.

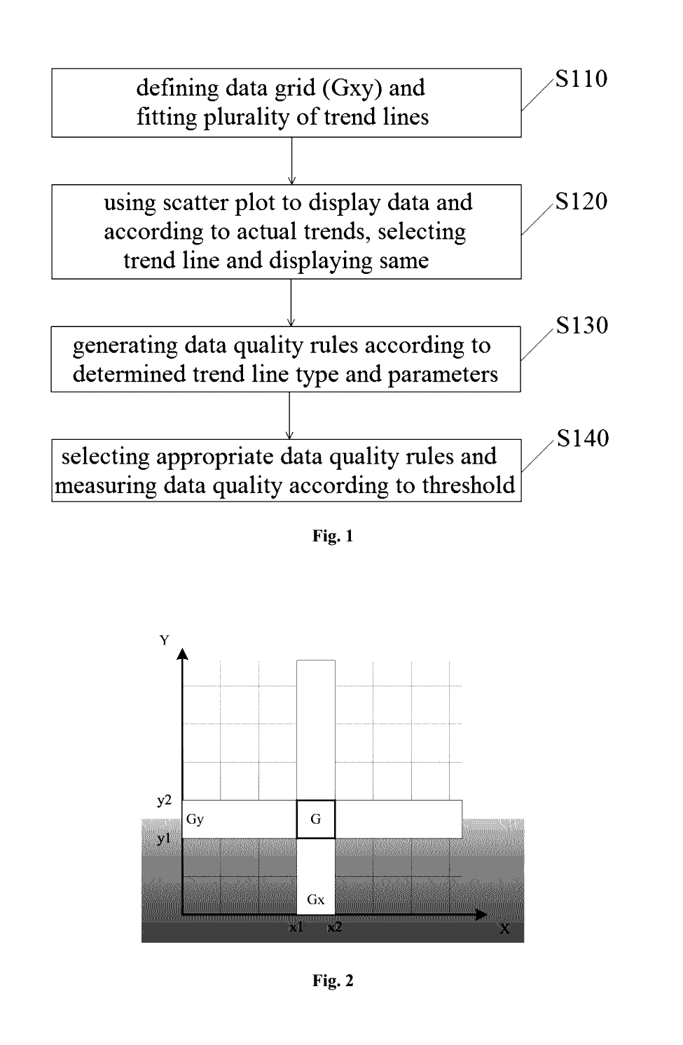

As shown in FIG. 1, it is a detailed flowchart illustrating a data quality measurement method based on a scatter plot provided by one embodiment of the present disclosure. The specific steps of the method are as follows:

Step S110: defining a data grid Gxy and fitting a plurality of trend lines.

Step S111: defining a data grid Gxy and scanning a data source.

To solve the problems that a simple scatter plot only represents a small amount of data and fails to display all points in a single graph in the case of huge amount of data to be displayed, therefore, in the embodiment of the present disclosure, the scatter plot is developed and a point in the developed scatter plot will no longer correspond to a specific recorded point, but a set of all recorded points satisfied {x1<=x<x2, y1<=y<y2}: a data grid Gxy. Referring to FIG. 2, the data grid is defined as follows:

defining Gx{x1, x2} as G{(x,y)|x1<=x<x2}, Gx for short, i.e., all points (x,y) satisfied x1<=x<x2;

defining Gy{y1,y2} as G{(x,y)|y1<=y<y2}, Gy for short, i.e., all points (x,y) satisfied y1<=y<y2;

defining the data grid Gxy as G{Gx,Gy}, i.e., all points simultaneously satisfied Gx and Gy.

Step S112: reading the data source, analyzing the stored data, and correcting the display scale of the X axis.

The data source is needed to be configured before reading the data, including configuration of the basis of the data source i.e. independent variable X and dependent variable Y. Then the data source is scanned to obtain the distribution of Y value and the minimum and maximum values of the variables X and Y, thus calculating the value ranges of X and Y. According to the value ranges, the minimum and maximum values are corrected. Four kinds of display scales of the X axis are figured out based on the value range of X. According to every recorded values of X and Y, i.e. x and y, the data grid Gxy corresponding to x y is calculated. With analysis of the stored data, the display scales of the X axis are corrected in a way that a small-level scale is deleted when the number of effective Gx within the small-level scale (if the record number within Gx is greater than 0, Gx is effective) is less than twice the number of effective Gx within its upper-level scale. The reason for deleting the scale is that, when the small-level scale is developed to the upper level scale, the resulting information does not increase much, so the details of actual data fail to be developed effectively. The maximal effective display scale to be determined to remain is the initial display scale.

Step S113: for every effective data grid Gxy of every effective display scale, the average value of X is calculated by dividing the sum of X by the total record number within the data grid, and the average value of Y is calculated by dividing the sum of Y by the total record number within the data grid.

Step S114: for every Gx of every effective display scale, calculating the general average value of X referred to the average value of X of all data within Gx and the general average value of Y, and fitting every type of trend lines based on the general average values.

The trend line types comprise:

straight line: y=a+b*x;

logarithmic curve: y=a+b*ln(x+1);

exponential curve: y=k+a*b̂x;

quadratic curve: y=a+b*x+c*x̂2;

Gompertz curve: y=k*â(b̂x);

logistic curve: y=1/(k+a*b̂x);

periodic curve: y=a*x+b*sin(c*x+d).

Step S120: using a scatter plot to display data and according to actual trends of the data, selecting a trend line and displaying same.

In one embodiment of the present disclosure, the processed data is displayed in the form of a scatter plot, wherein each data grid of the processed data represents a point in the scatter plot; for example, with respect to a data grid {[x1,x2), [y1,y2)}, the position of the point is {(x1+x2)/2, (y1+y2)/2}, the size of the point is determined by the record number contained within the data grid. The data information displayed by using the scatter plot at least comprises: scattered information of data, the average line of all Gx, the fitted trend lines and so on.

In one embodiment of the present disclosure, selecting a trend line according to actual trends of the data comprises: displaying the types of the trend lines on the scatter plot, performing selection according to actual trends of the data; manually adjusting the parameters of the trend line when the fitted trend line parameters fail to satisfy current data display; wherein the adjustment is achieved by means of directly adjusting the trend line formula in the scatter plot, or providing each parameter with support of dragging a mouse to modify the trend line and display the change of the trend line in real time when dragging the mouse to modify the trend line in the scatter plot.

Step S130: generating data quality rules according to the determined trend line type and parameters.

In one embodiment of the present disclosure, generating data quality rules comprises: providing that the trend line is y=f(x), i.e., for a value x, the target value y can be calculated according to the trend line; setting a threshold for the target value to generate data quality rules; wherein the threshold can be set to be an absolute value or in the form of a percentage. Provided that the trend line is y=f(x), i.e., for a value x, the target value y can be calculated according to the trend line, and giving a reasonable floating range (a threshold) to the target value, thereby configuring data quality rules. There are two ways to define the floating range. One is in the form of an absolute value, for example, supposing an upper limit is 50 and a lower limit is 40, when the target value is 200, the actual value is reasonable within the interval [160, 250]. Another way is in the form of a percentage, for example, supposing both the upper and lower limits are 20% and the target value is 200, the actual value is reasonable within the interval [160, 200]. The defined data rules can be saved to a rule base to be used later if necessary.

Step S140: selecting appropriate data quality rules and measuring data quality according to a threshold.

In one embodiment of the present disclosure, measuring data quality comprises: selecting appropriate data quality rules based on the actual situation of displaying data in the scatter plot, for each input data (x,y), calculating the target value y′ corresponding to x according to the trend line technique of the rules; configuring the threshold to be a value or a percentage, calculating the reasonable interval of the target value to judge the data quality of the actual value y. Provided that the trend of data rules is y=37.9+20*x/1000, the threshold is 20%, as for an input data (Ser. No. 10/000,213), its target value can be calculated, i.e., 37.9+20*10/1000=237.9, the reasonable interval is [237.9*0.8,237.9*1.2]=[190.32, 285.48], the actual value 213 belongs to the interval, so the data (Ser. No. 10/000,213) is a reasonable data. Similarly, the data (32000, 511) is determined as an abnormal data.

Another embodiment of the present disclosure provides a data quality measurement system based on a scatter plot, the system comprising:

a trend line fitting unit configured for defining a data grid Gxy and obtaining the information of fitting a plurality of trend lines;

a data display unit configured for using a scatter plot to display data and according to actual trends of the data, selecting a trend line and displaying same;

a data quality rules generating unit configured for generating data quality rules according to the determined trend line type and parameters and obtaining information of data quality rules;

a data quality measuring unit configured for selecting appropriate data quality rules, measuring data quality according to a threshold, and obtaining the result of data quality measurement.

Preferably, the trend line types selected by the data display unit comprise: straight line, logarithmic curve, exponential curve, quadratic curve, Gompertz curve, logistic curve, periodic curve and so on.

In one embodiment of the present disclosure, the data display unit selecting a trend line and displaying same according to actual trends of the data comprise:

displaying the types of the trend lines on the scatter plot, performing selection according to actual trends of the data;

manually adjusting the parameters of the trend line when the fitted trend line parameters fail to satisfy current data display; wherein

the adjustment is achieved by means of directly adjusting the trend line formula in the scatter plot, or providing each parameter with support of dragging a mouse to modify the trend line and display the change of the trend line in real time when dragging the mouse to modify the trend line in the scatter plot.

In one embodiment of the present disclosure, the data quality rules generating unit generating data quality rules comprises: providing that the trend line is y=f(x), i.e., for a value x, the target value y can be calculated according to the trend line; setting a threshold for the target value to generate data quality rules. By means of defining a data grid Gxy to store data, using a scatter plot to display data, and generating data quality rules according to a determined trend line type and parameters, and further setting a threshold according to said rules and measuring data quality, applications such as display of data, analysis of abnormal data and data error correction can be performed for enormous amounts of data.

What is described above is a further detailed explanation of the present disclosure in combination with specific embodiments; however, it cannot be considered that the specific embodiments of the present invention are only limited to the explanation. For those of ordinary skill in the art, some simple deductions or replacements can also be made under the premise of the concept of the present invention.

1. A data quality measurement method based on a scatter plot, wherein the method comprises the following steps:
defining a data grid (Gxy) and fitting a plurality of trend lines;
using a scatter plot to display data and according to actual trends of the data, selecting a trend line and displaying same;
generating data quality rules according to the determined trend line type and parameters;
selecting appropriate data quality rules and measuring data quality according to a threshold, wherein said defining a data grid (Gxy) and fitting a plurality of trend lines comprises:
defining a data grid (Gxy) and scanning a data source;
reading the data source, analyzing the stored data, and correcting the display scale of the X axis;
for every effective data grid (Gxy) of every effective display scale, according to the total record numbers of X and Y as well as the sums of X and Y, calculating the average values of X and Y;
for every Gx of every effective display scale, calculating the general average value of X and the general average value of Y, and fitting every type of trend line based on the general average values.

2. (canceled)

3. The method according to claim 1, wherein the trend lines comprise: straight line, logarithmic curve, exponential curve, quadratic curve, Gompertz curve, logistic curve, periodic curve.

4. The method according to claim 1, wherein the data information displayed by using a scatter plot at least comprises: scattered information of data, the average line of all Gx and the fitted trend lines.

5. The method according to claim 1, wherein said according to actual trends of the data selecting a trend line comprises:
displaying the types of the trend lines on the scatter plot, performing selection according to actual trends of the data;
manually adjusting the parameters of the trend line when the fitted trend line parameters fail to satisfy current data display; wherein
the adjustment is achieved by means of directly adjusting the trend line formula in the scatter plot, or providing each parameter with support of dragging a mouse to modify the trend line and display the change of the trend line in real time when dragging the mouse to modify the trend line in the scatter plot.

6. The method according to claim 1, wherein said generating data quality rules comprises:
providing that the trend line is y=f(x), i.e., for a value x, the target value y can be calculated according to the trend line;
setting a threshold for the target value to generate data quality rules.

7. The method according to claim 6, wherein the threshold is set to be an absolute value.

8. The method according to claim 6, wherein the threshold is set to be in the form of a percentage.

9. The method according to claim 1, wherein said measuring data quality comprises:
selecting data quality rules based on the actual situation of displaying data in the scatter plot, for each input data (x,y), calculating the target value y′ corresponding to x according to the trend line technique of the rules;
configuring the threshold to be a value or a percentage, calculating the reasonable interval of the target value to judge the data quality of the actual value y.

10-13. (canceled)
